(19) United States
(12) Patent Application Publication
(10) Pub. No.: US 2025/0315717 A1
(43) Pub. Date: Oct. 9, 2025

(54) ON-DEVICE MACHINE LEARNING MODEL

(71) Applicant: T-Mobile Innovations LLC, Overland Park, KS (US)

(72) Inventor: Do Kyu LEE, Mercer Island, WA (US)

(21) Appl. No.: 18/627,203

(22) Filed: Apr. 4, 2024

(51) Int. Cl. G06N 20/00

(52) U.S. Cl. CPC G06N 20/00

(57) ABSTRACT

Methods, systems, and apparatus, including computer programs encoded on a computer storage medium, for utilizing an on-device machine learning model are disclosed. In one aspect, a method includes the actions of receiving a model that is trained using machine learning and that is configured to determine a given cause of a given event associated with a computing device that is executing the application. The actions further include accessing device data. The actions further include accessing network data. The actions further include providing the device data, the network data, and data identifying an event associated with the computing device as an input to the model. The actions further include receiving, from the model, data indicating a cause of the event. The actions further include determining an action that remediates the cause of the event. The actions further include performing the action that remediates the cause of the event.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Machine learning (ML) is a form of artificial intelligence that gives computers the ability to learn and perform operations without being expressly programmed to perform those operations and/or to automatically refine and improve processing of a computer program (that was initially crafted by a human being) based on analysis of previous iterations of the program using training data and/or success criteria. For example, machine learning models may be used to perform image recognition, speech recognition, and predict events.

### SUMMARY

An innovative aspect of the subject matter described in this specification may be implemented in methods for using a model that is trained off a computing device to improve voice call quality on the computing device that include the actions of receiving, by an application of the computing device, the model that is trained using machine learning and that is configured to determine a given cause of a given event that is affecting given voice call quality on the computing device; accessing, by the application, device data that indicates characteristics of the computing device; accessing, by the application, network data that indicates characteristics of a network with which the computing device is communicating; providing, by the application, the device data, the network data, and data identifying an event that is affecting voice call quality on the computing device as an input to the model; receiving, by the application and from the model, data indicating a cause of the event; determining, by the application, an action that improves the voice call quality by remediating by remediating the cause of the event; and performing, by the application, the action that remediates the cause of the event.

Other implementations of this aspect include corresponding systems, apparatus, and computer programs recorded on computer storage devices, each configured to perform the operations of the method.

Another innovative aspect of the subject matter described in this specification may be implemented in a system configured to perform the operations of determining that an event associated with the system has occurred; accessing device data that indicates characteristics of the system; accessing network data that indicates characteristics of a network with which the system is communicating; based on the device data, the network data, and the event, selecting a model that is configured to receive the device data, the network data, and data identifying the event; receiving, from the model, data indicating a likely cause of the event; determining an action that likely remediates the likely cause of the event; and performing the action that likely remediates the likely cause of the event.

Other implementations of this aspect include corresponding methods, apparatus, and computer programs recorded on computer storage devices, each configured to perform these operations.

Another innovative aspect of the subject matter described in this specification may be implemented in computer programs recorded on computer storage devices configured to perform the operations of receiving a model that is trained using machine learning and that is configured to determine a given cause of a given event associated with the one or more computers; accessing device data that indicates characteristics of the one or more computers; accessing network data that indicates characteristics of a network with which the one or more computers are communicating; receiving an updated version of the model; providing the device data, the network data, and data identifying an event associated with the one or more computers as an input to the updated version of the model; receiving, from the updated version of the model, data indicating a likely cause of the event; determining an action that likely remediates the likely cause of the event; and performing the action that likely remediates the likely cause of the event.

Other implementations of this aspect include corresponding methods and apparatus, each configured to perform these operations.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an example system that is configured to use on-device machine learning processing to generate diagnostic information.

FIG. 2 illustrates various layers of an example computing system generating data for processing by a machine learning model to generate diagnostic information.

FIG. 3 is a flowchart of an example process for using on-device machine learning processing to generate diagnostic information.

FIG. 4 illustrates an example computer system.

FIG. 5 illustrates an example user equipment.

FIG. 6 illustrates a block diagram of an example user equipment.

FIG. 7 illustrates an example software environment that may be implemented by a digital signal processor.

FIG. 8 illustrates another example software environment that may be implemented by a digital signal processor.

### DETAILED DESCRIPTION

It should be understood at the outset that although illustrative implementations of one or more implementations are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

To determine the quality of a telephone call over a cellular network, the network operator may analyze data collected from the network side. Collecting and analyzing data collected from the network side to determine call quality may provide a one-sided view of the call quality. This may be because the data from the network side may not directly measure the quality of the call experienced by the user. By finding approaches to measure call quality and/or voice quality on the user equipment, a better and more actionable analysis may be obtained for understanding and improving call quality and/or voice quality. Using on device measurements and analyses may assist in providing results to improve call quality and/or voice quality where it matters most, for the users.

Monitoring and acting on call quality analysis on the user equipment can present challenges. On the network side, there are vast computing resources available to collect and process data. On the user equipment, the computing resources are more limited. Because of the limited resources, it may be necessary to remotely train (e.g., at a server in the network operator's domain), select, and import trained models to the user equipment. The user equipment can then manage and/or execute these trained models using the locally available computing resources. The selection of the models may allow the most appropriate model to be imported to the user equipment for the types of calls and/or transmissions to be monitored and improved. This selection of the model also optimizes the resources of the user equipment hosting the model.

Using on device measurements and models to analyze the data on the user equipment allows the models to analyze data that is closer to the real time degradation of the call quality and/or voice quality as experienced by the user. The models may also be configured to generate responses for local execution on the user equipment based on the gathered data to remediate the any issues affecting the call quality and/or voice quality. The on-device measurement and analysis using the trained model disclosed herein is a specific technical solution to the technical problem above.

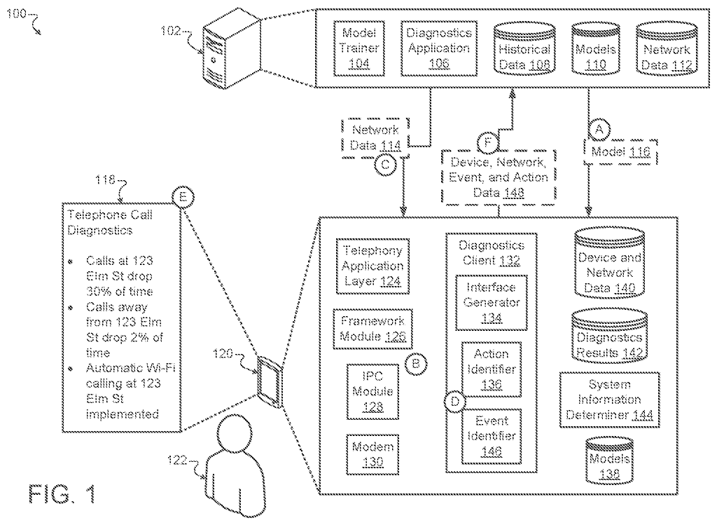

FIG. 1 illustrates an example system 100 that is configured to use on-device machine learning processing to generate diagnostic information. Briefly, and as described in more detail below, the computing device 120 includes various components and layers that each generate different types of data during their typical operations. These different types of data may be tied to various events associated with the computing device 120 that occur. These different types of data and events may be analyzed using models trained using machine learning and executed on the computing device. The models may identify likely causes of the events and actions to potentially correct the cause. The computing device 120 may also generate a graphical interface 118 that describes these events, causes, and/or actions and present the interface 118 to the user 122. FIG. 1 includes various stages A through F that may illustrate the performance of actions and/or the movement of data between various components of the system 100. The system 100 may perform these stages in any order.

In more detail, the user 122 is interacting with the computing device 120. The computing device 120 may be any type of device that is configured to communicate with other computing devices. For example, the computing device 120 may be a mobile phone, laptop computer, desktop computer, tablet, smart watch, server, and/or any other similar type of device. The computing device 120 may include various layers and modules that enable the computing device 120 to perform various operations. The operations may include placing and receiving phone calls, accessing the internet, executing various applications, storing and accessing data, communicating with other devices, and/or any other similar operation. During the execution of these operations, the various layers and modules may generate data. The devices that the computing device 120 may be communicating with during the execution of these operations may also generate data. The computing device 120 may include a diagnostics client 132 that is configured to use models 138 trained using machine learning to analyze the generated data. Based on this analysis, the diagnostics client 132 may be configured to identify various events, causes of those events, and/or actions to remediate any causes of those events.

The computing device 120 may include the capability to execute the models 138 trained using machine learning locally on the computing device 120. The computing device 120 may communicate with the server 102 during the operations described above and for other purposes. An example of the other purposes may include the server 102 providing the computing device with models that the server 102 trains using machine learning. In some instances, the computing device 120 may not have the capability to train machine learning models and relies on the server 102 to train the models, update the models, and provide the models and updated models to the computing device 120. The computing device 120 uses the models to analyze various types of data. The server 102 may be any type of device that is configured to communicate with other computing devices. For example, the server 102 may be a mobile phone, laptop computer, desktop computer, tablet, smart watch, server, and/or any other similar type of device.

In stage A, the server 102 may access the models 110 that the model trainer 104 trains using machine learning and the historical data 108. The training process and the historical data 108 may be described in more detail below. Briefly, the historical data 108 includes data collected from the computing device 120 and other computing devices and data collected from the server 102 and other servers. Within the historical data 108, different portions of the historical data 108 may be associated with various events. These events may connect with a user's use of the corresponding computing device. For example, an event may be a telephone call dropping, a telephone call being completed without dropping, an application crashing, an application being used without crashing, a data packet begin outputted by the computing device, a data packet being received by the computing device, a data packet being dropped before the computing device receives it, a data packet being dropped after the computing device outputs it and before a receiving device receives it, and/or any other similar type of event.

In some implementations, each event identified in the historical data 108 may be associated with a cause. For example, these causes may indicate a signal strength level that is below a threshold, a signal strength level that is above a threshold, a bandwidth that is above a threshold, a bandwidth that is below a threshold, an application has not been updated within a threshold period of time, an application has been updated within a threshold period of time, and/or any other similar cause of an event. In some implementations, each cause identified in the historical data 108 may be associated with an action that remediates the cause. For example, these actions may include connecting to a different network, connecting to a different access point to the network, updating an application, repositioning the computing device, using a different accessory with the computing device, and/or any other similar action.

The model trainer 104, which may be implemented by one or more processors executing computer-executable instructions, uses the historical data 108 to train the models 110 using machine learning. Depending on the data included in the historical data 108, the different models may be configured to receive different types of data and output different types of data. For example, some models may be configured to receive various types of device data, various types of network data, and data identifying an event. Some models may be configured to receive different types of device data, not network data, data identifying an event, and data identifying a cause. Some models may be configured to output data identifying a cause. Some models may be configured to output an action.

The server 102 may include a diagnostics application 106 that may be implemented by one or more processors executing computer-executable instructions. The diagnostics application 106 may be configured to interface with the diagnostics client 132 of the computing device. The diagnostics client 132 may also be implemented by one or more processors executing computer-executable instructions. The diagnostics application 106 may be configured to generate a model packet 116 that includes one or more of the models 110. The diagnostics application 106 may be configured to provide the model packet 116 to the computing device 120. The diagnostics application 106 may be configured to generate and provide the model packet 116 at various intervals. For example, the diagnostics application 106 may generate and provide the model packet 116 in response to a request from the diagnostics client 132. As another example, the diagnostics application 106 may generate and provide the model packet 116 in response to the model trainer 104 updating a model previously provided to the computing device 120. As another example, the diagnostics application 106 may generate and provide the model packet 116 in response to the model trainer 104 training a model that is configured to receive and/or output different types of data than the other models 110. As another example, the diagnostics application 106 may generate and provide the model packet 116 in response to the model trainer 104 training a new model that is configured to receive and/or output different types of data than the other models 110. In some implementations, the diagnostics application 106 may generate and provide the model packet 116 with the new model in response to determining that the computing device 120 has access to the type of data that the new model is configured to receive.

The computing device 120 may receive the model packet 116. The diagnostics client 132 may be configured to process the model packet 116 and store the one or more models included in the model packet 116 in the models 138. The diagnostics client 132 may be configured to analyze data collected from various components and layers of the computing device 120 as well as data received from other devices with which the computing device 120 communicates, such as the server 102. The diagnostics client 132 may manage the collection of data from these sources and store the data in the device and network data 140.

In stage B, the diagnostics client 132 may access data from the various components and layers of the computing device 120. The diagnostics client 132 may access data in an active manner. For example, the diagnostics client 132 may request data from a component and/or layer of the computing device 120 and the component and/or layer may respond with the requested data. The diagnostics client may access data in a passive manner. For example, the diagnostics client 132 may monitor data being received and/or outputted by the component and/or layer. The passive collection may be transparent to the component and/or layer because it does not involve the active participation of the component and/or layer.

The diagnostics client 132 may collect device data from the telephony application layer 124. The telephony application layer 124 may be configured to perform actions related to placing, receiving, and conducting telephone calls. The diagnostics client 132 may collect device data from the telephony application layer 124 that includes data related to attempted calls, incoming calls, connected calls, dropped calls, calls ended by a user, length of calls, data identifying other parties of the calls, and/or any other similar information. The diagnostics client 132 may also collect data related to the interactions of the user 122 with an interface of the telephony application layer 124. These interactions may include presses of buttons of the interface, an interface presented to the user 122, and/or any other similar interaction information. The diagnostics client 132 may store the device data collected from the telephony application layer 124 in the device and network data 140. The diagnostics client 132 may also include timestamps for the collected data.

The diagnostics client 132 may collect device data from the framework module 126. The framework module 126 may be configured to manage communications according to various protocols. The framework module 126 may include various layers such as a radio interface layer. The radio interface layer may be configured to manage the session initiation protocol (SIP) and/or the internet protocol multimedia subsystem (IMS). The diagnostics client 132 may collect various packets exchanged during SIP. These packets may include SIP invites, 183 packets, 18x packets, 180 packets, update packets, bye packets. Other packets may include those related to a session description protocol and telephony application server messages. The diagnostics client 132 may store the device data collected from the framework module 126 in the device and network data 140. The diagnostics client 132 may also include timestamps for the collected data.

The diagnostics client 132 may collect device data from the interprocess communication (IPC) module 128. The IPC module 128 may be configured to also manage communications according to various protocols. The diagnostics client 132 may collect device data related to radio resource control operations and interactions that may be associated with the IPC module 128. Other device data collected from the IPC module 128 may include non-access stratum (NAS) messages that may be related to physical downlink shared channels and/or physical uplink shared channels. Additional device data collected from the IPC module 128 may include third generation partnership project (3GPP) messages and data from a radio interface layer daemon. The diagnostics client 132 may store the device data collected from the IPC module 128 in the device and network data 140. The diagnostics client 132 may also include timestamps for the collected data.

The diagnostic client 132 may collect device data from the modem 130. The modem 130 may be configured to process outgoing data by modulating the data and processing incoming data by demodulating the data. The diagnostic client 132 may collect data related to the frequencies used by the incoming and outgoing data, the type of modulation, the amount of data received and output, and/or any other similar information. The diagnostics client 132 may store the device data collected from the modem 130 in the device and network data 140. The diagnostics client 132 may also include timestamps for the collected data.

The diagnostic client 132 may collect device data from the system information determiner 144. The system information determiner 144 may be configured to generate data related to the status of the computing device 120. This status data may include the location of the computing device 120, sensor data, battery data, operating system data, network connection data, radio frequency data, and/or any other similar type of data. The sensor data may be generated by an accelerometer, gravity sensor, ambient light sensor, proximity sensor, magnetism sensor, gyroscope, GPS sensor, hall sensor, fingerprint sensor, barometer, heart rate sensor, ultraviolet light sensor, blood oxygen sensor, temperature sensor, camera, microphone, humidity sensor, and/or any other similar sensor. The diagnostics client 132 may store the device data collected from the system information determiner 144 in the device and network data 140. The diagnostics client 132 may also include timestamps for the collected data.

In stage C, the diagnostics client 132 may interact with the diagnostics application 106 of the server 102. The server 102 may be incorporated with the wireless carrier network that provides wireless service to the computing device 120. The diagnostics client 132 may request and/or the diagnostics application 106 may provide automatically, data related to the network. The diagnostics application 106 may collect and store network data 112. The network data 112 may be base station specific. For example, the server 102 may be incorporated into a base station and the network data 112 may be data related to the base station such as a number of devices connected to the base station, the bandwidth used by each device, the available bandwidth of the base station, the timing of device connection and disconnections, the locations of devices connected to the base station, the frequencies and modulations used by the base stations, and/or any other similar characteristic. The network data 112 may be associated with multiple base stations. For example, the network data 112 may include data indicating the locations of the base stations, data indicating devices connecting and disconnecting from various base stations, and/or any of the other base station information previously noted. The network data 112 may also include timestamp data.

The diagnostics application 106 may generate the network data packet 114 that includes the network data 112. The server 102 may provide the network data packet 114 to the computing device 120. The diagnostics client 132 may store the network data packet 114 in the device and network data 140. The server 102 may provide the network data packet 114 to the computing device 120 at periodic intervals such as every hour, in response to a request from the diagnostics client 132, and/or in response to updating the network data 112.

In stage D, the diagnostics client 132 analyzes the device and network data 140 using the models 138. The diagnostics client 132 stores the results of the analysis in the diagnostics results 142. The diagnostics client 132 may include an event identifier 146. The event identifier 146 may be configured to analyze the device and network data 140 and identify an event for analysis. In some implementations, the event may be selected by the user 122. For example, the user 122 may request information on a dropped telephone call. In some implementations, the event may be an event that caused a negative result on the computing device 120. A negative result may include an application crashing, battery consumption higher than a threshold, signal strength that is lower than a threshold for a specific location, and/or any other similar negative results. In some implementations, the event may be the most recent predefined event. The predefined events may include telephone calls, application uses, message sent, message received, video calls, voicemails received, bandwidth usage that is greater than a threshold, switching network connections, switching base stations, interactions between the user 122 and the computing device 120, and/or any other similar type of event.

The event identifier 146 may be configured to analyze the device and network data 140 and determine the portion of the device and network data 140 associated with the event. The event identifier 146 may be configured to synchronize the various types of data stored in the device and network data 140 using the timestamps and other indicators to determine the portion of the device and network data 140 related to the event. In some implementations, the event identifier 146 may identify a portion of the device and network data 140 as related to the event if the device and network data 140 is within a period of time before or after the time of the event. In some implementations, the period of time may be different depending on the source of the data. For example, data from the modem 130 may have a period of time of three minutes before and after the event, including the time during the event. As another example, data from the telephony application layer 124 may have a period of time of five minutes before and after the event, including the time during the event. In some implementations, these periods of time may be specified by the models 138 used to analyze data related to the event.

In some implementations, the period of time for collecting data may change depending on an importance level indicated by the user 122. For example, the user 122 may indicate that dropped calls are a priority and determining cause of the dropped calls is a priority. In this case, the event identifier 146 may increase the period of time for collecting data for dropped call events from a default period of time in response to the user input. In some implementations, the period of time for collecting data may change in response to previous attempts to identify a cause of the event. Unsuccessful attempts may cause the event identifier 146 to incrementally increase the period of time for collecting data each time the diagnostics client 132 unsuccessfully identifies a cause of the event. After identifying a cause of the event, the event identifier 146 may return to a default period of time for collecting data for the event.

The diagnostics client 132 may select a model from the models 138 based on the portion of the device and network data 140 selected by the event identifier 146 and/or the event identified by the event identifier 146. The diagnostics client 132 may select a model that is configured to receive the type of data included in the portion of the device and network data 140 and data identifying the event. In some implementations, the models 138 may not include a model that is configured to receive the portion of the device and network data 140 selected by the event identifier 146. In this case, the diagnostics client 132 may identify the models that are configured to receive data identifying the event. The diagnostics client 132 may select the corresponding portion of the device and network data 140 according to the data that the model is configured to receive.

The diagnostics client 132 may provide the portion of the device and network data 140 and data identifying the event to the selected model. The model may output data identifying a likely cause of the event. In some implementations, the model may output a confidence score that indicates a likelihood that the likely cause is correct. In some implementations, the diagnostics client 132 may identify more than one model that is configured to receive the type of data included in the portion of the device and network data 140 and data identifying the event. In this case, the diagnostics client 132 may provide the input data to each of the identified models. If the models identify different likely causes, then the diagnostics client 132 may select the likely cause from the model with the highest confidence score. In some implementations, there may be more than one cause. In this case, the model or models may output more than one cause. Additionally, or alternatively, the diagnostics client 132 may select the likely causes from the models with a confidence score that is above a threshold and/or the causes with the highest confidence scores from a predetermined number of models.

With the event and the likely cause of the event identified, the action identifier 136 may determine an action that is configured to remediate the cause. In some implementations, the diagnostics client 132 may instruct the action identifier 136 on whether to determine an action. The instructions from the diagnostics client 132 may depend on the event and/or the cause. If the event is an undesirable event and/or the cause is an undesirable cause, then the diagnostics client 132 may instruct the action identifier 136 to determine an action to remediate the causes. In some implementations, the undesirable events and/or causes may be predetermined. In some implementations, the undesirable events and/or causes may be events or causes that the user 122 or other users have indicated should be corrected.

To determine an action that will likely remediate the event, the action identifier 136 may utilize the models 138. The action identifier 136 may select a model that is configured to receive the portion of the device and network data 140 provided to the cause identifying model and data identifying the cause. In some implementations, the model may also be configured to identify the event. The action identifier 136 may determine that none of the models 138 are configured to receive the portion of the device and network data 140 provided to the cause identifying model and data identifying the cause, and optionally, data identifying the event. In this case, the action identifier 136 may increase or decrease the portion of the device and network data 140 and/or add or remove types of data included in the portion of the device and network data 140. The action identifier 136 may attempt to adjust the portion of the device and network data 140 to fit a model that is configured to receive data identifying cause.

The action identifier 136 may provide the portion of the device and network data 140, updated as necessary, data identifying the cause, and data identifying the event, if the model is configured to receive that type of input. The model may output data identifying an action that is likely to mitigate the cause. In some implementations, the model may output a confidence score. If the action identifier 136 selects more than one model, then the action identifier 136 may select the action with the highest confidence score. In some implementations, the action identifier 136 may select an action in a similar fashion to the diagnostics client 132 selects one or more causes when providing input to multiple models.

In some implementations, the diagnostics client 132 may automatically implement the action. Whether the diagnostics client 132 implements the action may depend on the action. For example, the diagnostics client 132 may automatically implement actions such as updating software, switching to a different network, changing a way that an application accomplishes an operation, and/or any other similar action. The diagnostics client 132 may automatically implement actions that may not cause disruption to the user 122. The diagnostics client 132 may request permission to perform an action and or recommend that the user 122 perform the action if the action is likely to disrupt the user 122 and/or cause a change to any data stored by the user 122. For example, the diagnostics client 132 may request permission to delete an application and install another application to accomplish a similar operation.

In some implementations, the diagnostics client 132 may determine whether the cause was corrected by the action. The diagnostics client 132 may be configured to analyze newly received device and network data 140 using the models 138 to determine whether the action remediated the likely cause and/or whether the likely cause of the event was the actual cause. The diagnostics client 132 may analyze the newly received device and network data 140 in a similar fashion as described above with respect to the previously received device and network data 140. In some implementations, the diagnostics client 132 may request feedback from the user 122 to determine whether the action remediated the likely cause and/or whether the likely cause of the event was the actual cause.

With the event, cause, and action identified, the diagnostics client 132 updates the diagnostic results 142. The diagnostics client 132 may also store data identifying the portions of the device and network data 140 used to determine the event, cause, and action and the models used to analyze the portions of the device and network data 140. In the case where the action was implemented either automatically or by the user 122, the diagnostics client 132 also includes that information in the diagnostic results 142. In the case where the diagnostics client 132 determines or receives feedback as to whether the action remediated the likely cause and/or whether the likely cause of the event was the actual cause, the diagnostics client 132 may store that data in the diagnostic results 142 as well.

In stage E, the interface generator 134 of the diagnostics client 132 generates an interface 118 that summarizes the diagnostic results 142. The interface generator 134 provides the interface 118 to a display of the computing device 120. The user 122 may interact with the interface 118, provide feedback, and/or take any recommended action. In instances where the diagnostics client 132 automatically executes the action, the interface generator 134 may include that performance of the action in the interface 118. In instances where the diagnostics client 132 recommends execution of the action, the interface generator 134 may include a selectable option to perform the action.

In some implementations, the interface generator 134 may include a request for feedback in the interface 118. The feedback request may request that the user 122 provide feedback as to whether the action remediated the likely cause and/or whether the likely cause of the event was the actual cause. The diagnostics client 132 may store the feedback in the diagnostic results 142.

In the example of FIG. 1, the event identifier 146 may have identified the event that telephone calls drop at a rate of thirty percent at the location of 123 Elm St. The event identifier 146 may have identified another event that telephone calls drop at a rate of two percent at locations other than 123 Elm St. The diagnostics client 132 may have determined that the likely cause of the high call dropping rate at 123 Elm St was a low signal strength at 123 Elm St. The action identifier 136 may have determined that an action that would likely mitigate the cause would be to switch to Wi-Fi calling while at 123 Elm St. Because that action would not modify how the computing device 120 appears to function to the user 122, the diagnostics client 132 automatically implemented the action. The interface 118 may reflect these events, causes, and/or actions. The interface 118 may also indicate whether the actions have been automatically implemented.

In stage F, the diagnostics client 132 may generate a device, network, event, and action data packet 148. The computing device 120 may provide this device, network, event, and action data packet 148 to the server 102. This packet 148 may include data identifying the portion of the device and network data 140, the event, the likely cause, and/or the action that likely remediated the cause. The packet 148 may also include data confirming whether the likely cause was the actual cause and/or whether the action remediated the cause. The server 102 may store the packet 148 in the historical data 108. The model trainer 104 may retrain the models 110 and provide updated models to the computing device 120.

Returning to the training of the models 110, the historical data 108 may include data similar to the data in the device and network data 140 and the diagnostic results 142 as well as data similar to that included in the device, network, event, and action data packet 148. The historical data 108 may include these types of data for multiple computing devices not just computing device 120. The historical data 108 may also receive similar data from other servers throughout the network.

The model trainer 104 may generate various data samples from the historical data 108. The data samples may represent a snap shot of the status of a computing device at a point in time. Each data sample may include a label such as the cause of the event related to the data sample and/or the action that was performed to remediate the cause of the event related to the data sample. Some data samples may include the data from other data samples. This may be because there are multiple data samples related to a single event. A first data sample may include a snap shot of the computing device at a first point in time and the corresponding historical data. A second data sample may include a snap shot of the computing device at a second point in time as well as the data from the snap shot at the first point in time. Each of the first and second data samples may include a same label. With these data samples, the model trainer 104 may train the models 110 to continuously receive input data collected from the computing device. As a model receives more input data, the likelihood of the model outputting an accurate result increases.

The model trainer 104 may update, or retrain the models 110 as the server 102 receives the device, network, event, and action data packet 148 and other similar feedback from the devices that used the models to identify causes and actions. The model trainer 104 may generate new data samples and combine the new data samples with the previous data samples to retrain the models 110. The server 104 may provide the updated models to the computing device 120. This feedback cycle may continue and the accuracy of the models 110 may continuously improve.

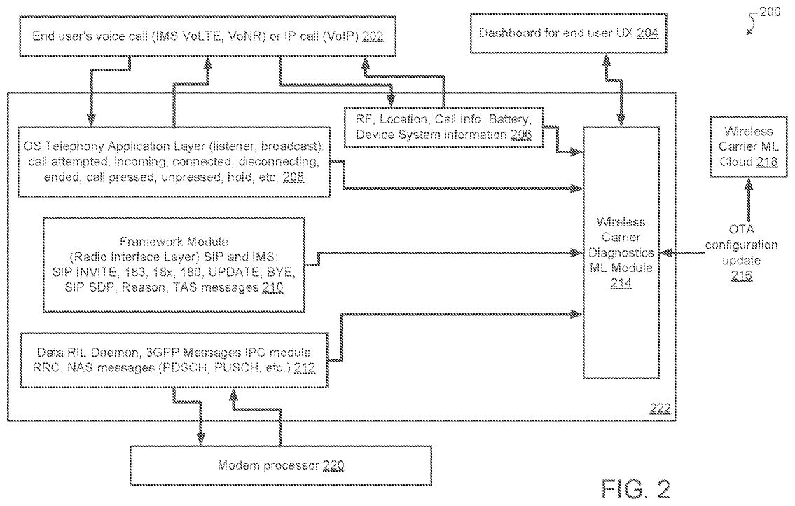

FIG. 2 illustrates various layers of an example computing system 200 generating data for processing by a machine learning model to generate diagnostic information. The system 200 may be any type of computing device that is configured to communicate with other computing devices. The system 200 may communicate with other computing devices using a wide area network, a local area network, the internet, a wired connection, a wireless connection, and/or any other type of network or connection. The wireless connections may include Wi-Fi, short-range radio, infrared, cellular, and/or any other wireless connection. The system 200 may be similar to the server 102 of FIG. 1. Some of the components of the system 200 may be implemented in a single computing device or distributed over multiple computing devices. Some of the components may be in the form of virtual machines or software containers that are hosted in a cloud in communication with disaggregated storage devices.

The system 200 includes a wireless carrier diagnostics machine learning module 214. The wireless carrier diagnostics machine learning module 214 may be similar to the diagnostics client 132 of FIG. 1. The wireless carrier diagnostics machine learning module 214 may be configured to analyze various types of data to determine events that are related to the system. The wireless carrier diagnostics machine learning module 214 uses machine learning models to identify likely causes of those events and actions that are likely to remediate those likely causes.

The wireless carrier diagnostics machine learning module 214 may receive data from the radio frequency (RF), location, cellular information, battery, and device system information module 206. The RF, location, cellular information, battery, and device system information module 206 may be similar to the system information determiner 144 of FIG. 1. The RF, location, cellular information, battery, and device system information module 206 may be configured to generate status data related to the components of the system 200 such as the battery, location, sensor data, and/or any other similar data.

The wireless carrier diagnostics machine learning module 214 may receive data from the operating system telephony application layer 208. The operating system telephony application layer 208 may be similar to the telephony application layer 124 of FIG. 1. The operating system telephony application layer 208 may be configured to generate data related to attempted telephone calls, incoming calls, connected calls, disconnected calls, ended calls, calls that start or end in response to input from a user, calls that start or end without input from the user, calls that are placed on and removed from hold, and/or any other similar data.

The radio frequency (RF), location, cellular information, battery, and device system information module 206 and the operating system telephony application layer 208 may be configured to communicate and/or receive data from user telephone calls 202. The user telephone calls 202 may generate some of the data for the radio frequency (RF), location, cellular information, battery, and device system information module 206 and the operating system telephony application layer 208. The user telephone calls 202 may include those telephone calls placed and received by an end user of the system 200. These calls may be internet protocol calls such as voice over internet protocol calls. These calls may be voice calls such as internet protocol multimedia subsystem, voice over long-term evolution, and/or voice over new radio.

The wireless carrier diagnostics machine learning module 214 may receive data from the framework module 210. The framework module 210 may be similar to the framework module 126 of FIG. 1. The framework module 210 may include and/or communicate with the radio interface layer of the system 200. The radio interface layer may manage session information protocol (SIP) communications and internet protocol multimedia subsystem (IMS) communications. Some of these communications may include SIP invites, 183 packets, 18x packets, 180 packets, SIP updates, SIP byes, SIP session description protocol messages, reason messages, telephony application server messages, and/or any other similar packets or messages.

The wireless carrier diagnostics machine learning module 214 may receive data from the interprocess communication (IPC) module 212. The IPC module 212 may be similar to the IPC module 128 of FIG. 1. The IPC module 212 may generate data related to a radio interface layer daemon, 3GPP messages, radio resource control messages, non-access stratum messages related to physical downlink shared channels and/or physical uplink shared channels, and/or any other similar messages.

The IPC module 212 may communicate with the model 220. The modem 220 may be similar to the modem 130 of FIG. 1. The IPC module 212 may interact with the modem 220 to determine various characteristics of the radio frequency signals that the system 200 is receiving and outputting. The characteristics of the radio frequency signals may include the frequency, the modulation scheme, the destination, the recipient, the bitrate, bandwidth used, available bandwidth, and/or any other similar characteristic.

The wireless carrier diagnostics machine learning module 214 may communicate with the wireless carrier machine learning cloud 218. The function of the wireless carrier machine learning cloud 218 may be similar to the model trainer 104 and other components of FIG. 1. The wireless carrier machine learning cloud 218 may be configured to train various machine learning models and provide those models to the wireless carrier diagnostics machine learning module 214 through an over the air configuration update 216. The wireless carrier diagnostics machine learning module 214 may provide the wireless carrier diagnostics machine learning module 214 data for training the models through the communication channel used for the over the air configuration update 216. The wireless carrier machine learning cloud 218 may provide updated models as the wireless carrier machine learning cloud 218 trains the models and/or in response to a request from the wireless carrier diagnostics machine learning module 214.

The wireless carrier diagnostics machine learning module 214 may generate a user interface 204. The user interface 204 may be similar to the user interface 118 of FIG. 1. The user interface 204 may include information that summarizes any events, causes, and/or actions identified by the wireless carrier diagnostics machine learning module 214. The user interface 204 may include recommendations and/or an indication of actions automatically taken by the system 200.

As described above, the wireless carrier diagnostics machine learning module 214 may be configured to analyze data collected from components of the system 200 and/or data collected from other computing devices and networks with which the system 200 is communicating. This process may involve machine learning modeling of on-device statistics and logic. For example, determining whether call drops are normal or abnormal and/or whether call setup failures are normal or abnormal. The process may utilize a machine learning model received from the cloud with more regional radio frequency data received via over the air for an on-device machine learning module update, which may improve accuracy. The process may generate on-device statistics that may be output in a weekly report through a user interface and/or notifications to the user via a message or a notification alarm.

As a more detailed example involving the on-device analysis of call drops, call setup, and call quality, the wireless carrier diagnostics machine learning module 214 may perform several operations. The wireless carrier diagnostics machine learning module 214 may check the on-device status of call drop and setup failures and check internet protocol multimedia subsystem data metrics. The wireless carrier diagnostics machine learning module 214 may check radio frequency signal quality and check holdover scenario quality. The wireless carrier diagnostics machine learning module 214 may determine if these data items can be reported to the user on a dashboard. The wireless carrier diagnostics machine learning module 214 may collect a server over the air status of the regional data based on not being over a threshold of confidence of the machine learning model support vector machine.

The wireless carrier diagnostics machine learning module 214 may perform several operations to present the user with an interaction message or a user interface menu. The wireless carrier diagnostics machine learning module 214 may aggregate data from a cloud machine learning model and update the library over the air to a carrier application or billing application. This may involve A/B testing and/or comparisons as needed to improve accuracy. The wireless carrier diagnostics machine learning module 214 may provide a menu for the user. The menu may be a passive menu that the user can look up to view or an active menu delivered through a notification message.

The wireless carrier diagnostics machine learning module 214 may perform several operations to provide feedback to the network machine learning system based on the applied on-device machine learning model. The wireless carrier diagnostics machine learning module 214 may collect call logs including phone numbers. The wireless carrier diagnostics machine learning module 214 may detect if these numbers are arbitrary and/or potential contact numbers using the data sets of the system 200 for the voice calls of the user in the device. The wireless carrier diagnostics machine learning module 214 may look up and check the validity of the phone numbers to determine whether they are consumer or business numbers. The wireless carrier diagnostics machine learning module 214 may provide candidates for adding to the address book through a message dialog and/or statistics dashboard.

There may be several categories of characteristics and other data that the wireless carrier diagnostics machine learning module 214 can be configured to analyze. A category may include determining the health condition of the system 200. This analysis may involve analyzing objects such as packet loss, SIP messages, reference signal received power conditions, and data throughput latency. The parsing logic for the machine learning training process may analyze losses in the same call session, anomaly events and a percent of the correlation environment, such as device environment health. The parsing logic may also include a check for correlation signal level, a check for an AFR reason delay between 183 and 180, and a check for zero-rate latency throughput. An example Y label, for server-device, may be anomaly data vs device status correlation, such as an array with data anomaly statistics. The Y label may indicate the type of data that the model is trained to predict.

Another category may include smart frequency sampling. This analysis may involve analyzing objects such as reference signal received power conditions, battery conditions, negative acknowledgements, error response conditions, and/or data event triggers. The parsing logic may include improved retry logic, A/B comparison sampling and test sets. A/B comparisons may be used to refine the collection condition, such as a key performance indicator result, base count, location, usage, which may be heavy, medium, or rare. An example Y label, for server-device, may be determining frequency on-device data, and/or dynamic frequency configurations, such as get/post with or without configuration server.

Another category of analysis performed by the parsing logic may include application programing interfaces. This analysis may involve analyzing new location objects. The parsing logic may include a collected location evaluation on the device. The example Y label, for server-device, may include a location polling time.

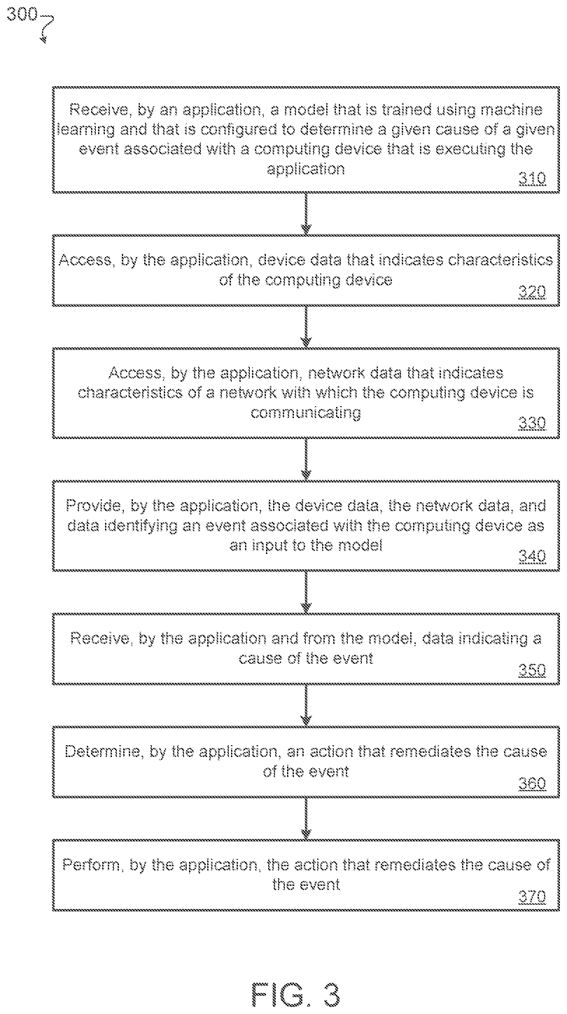

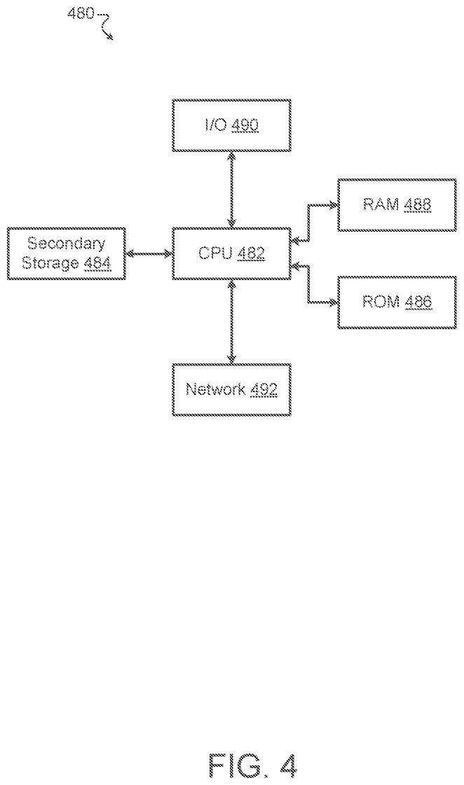

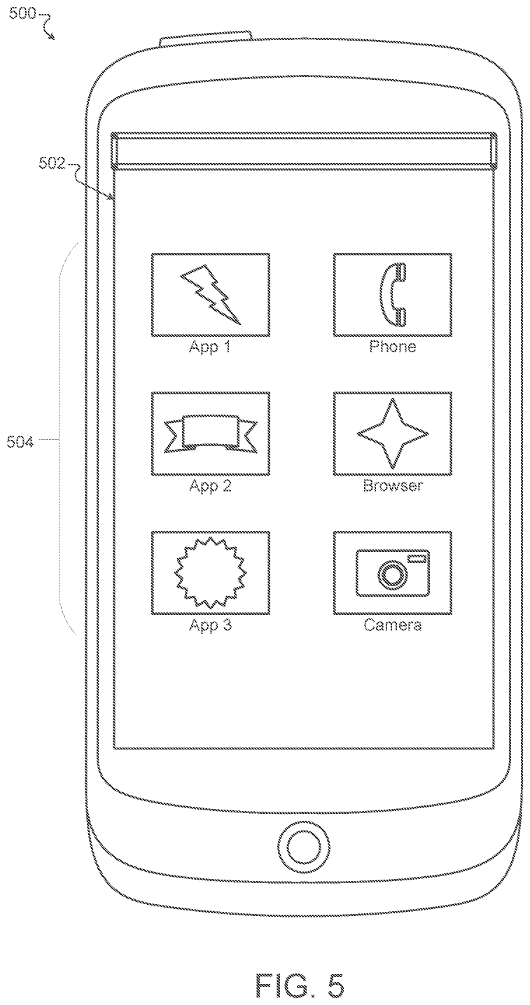

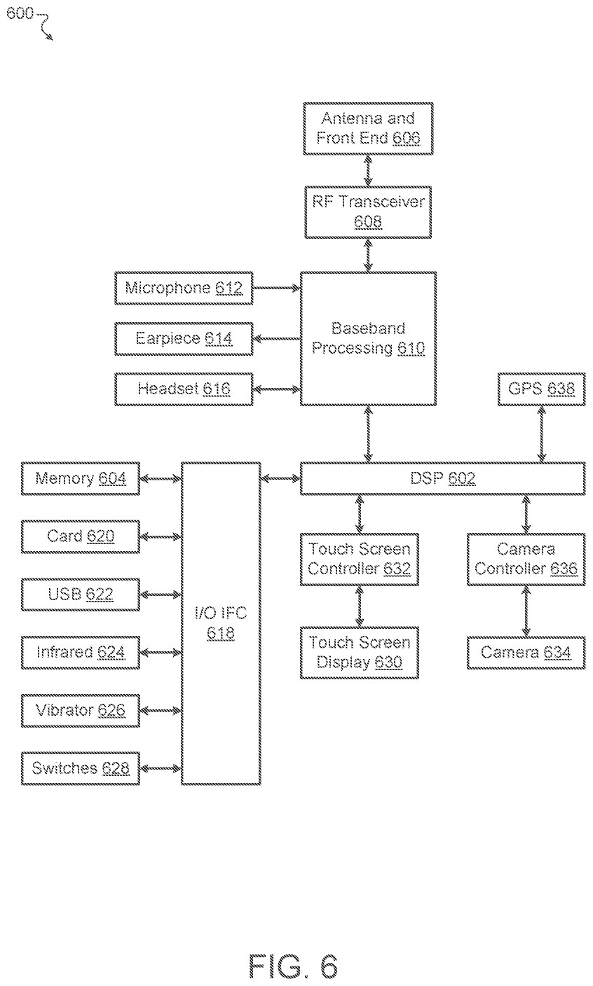

FIG. 3 is a flowchart of an example process 300 for using on-device machine learning processing to generate diagnostic information. In general, the process 300 uses an on-device machine learning trained model to analyze data collected from the device and/or data collected from other devices communicating with the device. The process 300 may use the machine learning trained models to determine events that are related to the data, causes of those events, and/or actions to remediate the causes of those events. The process 300 may automatically implement the actions. The process 300 will be described as being performed by the computing device 120 and will include references to other components in FIG. 1. In some implementations, the process 300 may be performed by the system 200 of FIG. 2, the system 480 of FIG. 4 discussed below, the user equipment 500 of FIG. 5 discussed below, and/or the user equipment 600 of FIG. 6 discussed below. The process 300 may be performed by a single computing device or split across multiple computing devices that may include virtual devices.

The device 120 receives a model that is trained using machine learning and that is configured to determine a given cause of a given event associated with a computing device 120 that is executing the application (310). In some implementations, another computing device, such as the server 102, trains the model. The other computing device may use training data that includes historical data 108 that includes data previously collected from the computing device 120, data generated by the server 102, data identifying previous events, data identifying previous causes of the events, and data identifying previous actions used to remediate the causes.

The computing device 120 accesses device data that indicates characteristics of the computing device 120 (320). In some implementations, the computing device 120 may access the device data from a telephony application layer 124, framework module 126, modem 130, and/or interprocess communication module 128. The characteristics may include the various types of data that each of the layers and modules are configured to generate. These types of data may include any of the types of data described above.

The computing device 120 accesses network data that indicates characteristics of a network with which the computing device 120 is communicating (330). The network data may include data related to the base station with which the computing device 120 is communicating and/or other base stations with which the computing device 120 has communicated. The network data may include any type of data described above.

The computing device 120 provides the device data, the network data, and data identifying an event associated with the computing device 120 as an input to the model (340). In some implementations, the computing device 120 may receive an updated model and may provide the device data, the network data, and the data identifying an event to the updated model. In some implementations, the computing device 120 may access the model and determine the input requirements of the model. The computing device 120 may request the data needed by the model from the various layers and modules of the device and from the server 102. This technique may minimize the need of the computing device 120 to store large amounts of data in anticipation of providing the data to a model.

The computing device 120 receives, from the model, data indicating a cause of the event (350). In some implementations, the model may output a confidence score that indicates a likelihood that the cause is the actual cause of the event. The computing device 120 determines an action that remediates the cause of the event (360). In some implementations, the computing device 120 may provide the device data, the network data, the data identifying the event, and/or the data identifying the likely cause of the event to an additional model that is configured to determine the action that likely remediates the cause of the event. Like the other model, this additional model may be trained using machine learning and historical data that includes previous device data, previous network data, data identifying previous events, previous causes of the previous events, and previous actions that remediated the previous events.

The computing device 120 performs the action that remediates the cause of the event (370). In some implementations, the computing device 120 performs the action automatically. In some implementations, the computing device 120 recommends that the user 122 perform the action. In some implementations, the computing device 120 generates and outputs an interface that indicates the automatic performance of the action or recommends that the user 122 perform the action.

In some implementations, the computing device 120 receives data confirming that the cause was the actual cause of the event and/or that the action remediated the cause. The computing device 120 may provide this feedback to the server 102. The server 102 may use this data to retrain the models and provide the retrained models back to the computing device 120.

FIG. 4 illustrates an example computer system 480 suitable for implementing one or more implementations disclosed herein. The computer system 480 includes a processor 482 (which may be referred to as a central processor unit or CPU) that is in communication with memory devices including secondary storage 484, read only memory (ROM) 486, random access memory (RAM) 488, input/output (I/O) devices 490, and network connectivity devices 492. The processor 482 may be implemented as one or more CPU chips.

It is understood that by programming and/or loading executable instructions onto the computer system 480, at least one of the CPU 482, the RAM 488, and the ROM 486 are changed, transforming the computer system 480 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 480 is turned on or booted, the CPU 482 may execute a computer program or application. For example, the CPU 482 may execute software or firmware stored in the ROM 486 or stored in the RAM 488. In some cases, on boot and/or when the application is initiated, the CPU 482 may copy the application or portions of the application from the secondary storage 484 to the RAM 488 or to memory space within the CPU 482 itself, and the CPU 482 may then execute instructions that the application is comprised of. In some cases, the CPU 482 may copy the application or portions of the application from memory accessed via the network connectivity devices 492 or via the I/O devices 490 to the RAM 488 or to memory space within the CPU 482, and the CPU 482 may then execute instructions that the application is comprised of. During execution, an application may load instructions into the CPU 482, for example load some of the instructions of the application into a cache of the CPU 482. In some contexts, an application that is executed may be said to configure the CPU 482 to do something, e.g., to configure the CPU 482 to perform the function or functions promoted by the subject application. When the CPU 482 is configured in this way by the application, the CPU 482 becomes a specific purpose computer or a specific purpose machine.

The secondary storage 484 is typically comprised of one or more disk drives or tape drives and is used for non-volatile storage of data and as an over-flow data storage device if RAM 488 is not large enough to hold all working data. Secondary storage 484 may be used to store programs which are loaded into RAM 488 when such programs are selected for execution. The ROM 486 is used to store instructions and perhaps data which are read during program execution. ROM 486 is a non-volatile memory device which typically has a small memory capacity relative to the larger memory capacity of secondary storage 484. The RAM 488 is used to store volatile data and perhaps to store instructions. Access to both ROM 486 and RAM 488 is typically faster than to secondary storage 484. The secondary storage 484, the RAM 488, and/or the ROM 486 may be referred to in some contexts as computer readable storage media and/or non-transitory computer readable media.

I/O devices 490 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 492 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 492 may provide wired communication links and/or wireless communication links (e.g., a first network connectivity device 492 may provide a wired communication link and a second network connectivity device 492 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In some implementations, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 492 may enable the processor 482 to communicate with the Internet or one or more intranets. With such a network connection, it is contemplated that the processor 482 might receive information from the network, or might output information to the network in the course of performing the above-described method steps. Such information, which is often represented as a sequence of instructions to be executed using processor 482, may be received from and outputted to the network, for example, in the form of a computer data signal embodied in a carrier wave.

Such information, which may include data or instructions to be executed using processor 482 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 482 executes instructions, codes, computer programs, scripts which it accesses from hard disk, floppy disk, optical disk (these various disk-based systems may all be considered secondary storage 484), flash drive, ROM 486, RAM 488, or the network connectivity devices 492. While only one processor 482 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 484, for example, hard drives, floppy disks, optical disks, and/or other device, the ROM 486, and/or the RAM 488 may be referred to in some contexts as non-transitory instructions and/or non-transitory information.

In some implementations, the computer system 480 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In some implementations, virtualization software may be employed by the computer system 480 to provide the functionality of a number of servers that is not directly bound to the number of computers in the computer system 480. For example, virtualization software may provide twenty virtual servers on four physical computers. In some implementations, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In some implementations, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 480, at least portions of the contents of the computer program product to the secondary storage 484, to the ROM 486, to the RAM 488, and/or to other non-volatile memory and volatile memory of the computer system 480. The processor 482 may process the executable instructions and/or data structures in part by directly accessing the computer program product, for example by reading from a CD-ROM disk inserted into a disk drive peripheral of the computer system 480. Alternatively, the processor 482 may process the executable instructions and/or data structures by remotely accessing the computer program product, for example by downloading the executable instructions and/or data structures from a remote server through the network connectivity devices 492. The computer program product may comprise instructions that promote the loading and/or copying of data, data structures, files, and/or executable instructions to the secondary storage 484, to the ROM 486, to the RAM 488, and/or to other non-volatile memory and volatile memory of the computer system 480.

In some contexts, the secondary storage 484, the ROM 486, and the RAM 488 may be referred to as a non-transitory computer readable medium or a computer readable storage media. A dynamic RAM implementation of the RAM 488, likewise, may be referred to as a non-transitory computer readable medium in that while the dynamic RAM receives electrical power and is operated in accordance with its design, for example during a period of time during which the computer system 480 is turned on and operational, the dynamic RAM stores information that is written to it. Similarly, the processor 482 may comprise an internal RAM, an internal ROM, a cache memory, and/or other internal non-transitory storage blocks, sections, or components that may be referred to in some contexts as non-transitory computer readable media or computer readable storage media.

FIG. 5 depicts the user equipment (UE) 500, which is operable for implementing aspects of the present disclosure, but the present disclosure should not be limited to these implementations. Though illustrated as a mobile phone, the UE 500 may take various forms including a wireless handset, a pager, a personal digital assistant (PDA), a gaming device, or a media player. The UE 500 includes a touchscreen display 502 having a touch-sensitive surface for input by a user. A small number of application icons 504 are illustrated within the touch screen display 502. It is understood that in different embodiments, any number of application icons 504 may be presented in the touch screen display 502. In some embodiments of the UE 500, a user may be able to download and install additional applications on the UE 500, and an icon associated with such downloaded and installed applications may be added to the touch screen display 502 or to an alternative screen. The UE 500 may have other components such as electro-mechanical switches, speakers, camera lenses, microphones, input and/or output connectors, and other components as are well known in the art. The UE 500 may present options for the user to select, controls for the user to actuate, and/or cursors or other indicators for the user to direct. The UE 500 may further accept data entry from the user, including numbers to dial or various parameter values for configuring the operation of the handset. The UE 500 may further execute one or more software or firmware applications in response to user commands. These applications may configure the UE 500 to perform various customized functions in response to user interaction. Additionally, the UE 500 may be programmed and/or configured over-the-air, for example from a wireless base station, a wireless access point, or a peer UE 500. The UE 500 may execute a web browser application which enables the touch screen display 502 to show a web page. The web page may be obtained via wireless communications with a base transceiver station, a wireless network access node, a peer UE 500 or any other wireless communication network or system.

FIG. 6 shows a block diagram of a UE 600. The UE 600 may be similar to the UE 500 of FIG. 5. While a variety of known components of handsets are depicted, in an embodiment a subset of the listed components and/or additional components not listed may be included in the UE 600. The UE 600 includes a digital signal processor (DSP) 602 and a memory 604. As shown, the UE 600 may further include one or more antenna and front end unit 606, a one or more radio frequency (RF) transceiver 608, a baseband processing unit 610, a microphone 612, an earpiece speaker 614, a headset port 616, an input/output interface 618, a removable memory card 620, a universal serial bus (USB) port 622, an infrared port 624, a vibrator 626, one or more electro-mechanical switches 628, a touch screen display 630, a touch screen controller 632, a camera 634, a camera controller 636, and a global positioning system (GPS) receiver 638. In an embodiment, the UE 600 may include another kind of display that does not provide a touch sensitive screen. In an embodiment, the UE 600 may include both the touch screen display 630 and additional display component that does not provide a touch sensitive screen. In an embodiment, the DSP 602 may communicate directly with the memory 604 without passing through the input/output interface 618. Additionally, in an embodiment, the UE 600 may comprise other peripheral devices that provide other functionality.

The DSP 602 or some other form of controller or central processing unit operates to control the various components of the UE 600 in accordance with embedded software or firmware stored in memory 604 or stored in memory contained within the DSP 602 itself. In addition to the embedded software or firmware, the DSP 602 may execute other applications stored in the memory 604 or made available via information carrier media such as portable data storage media like the removable memory card 620 or via wired or wireless network communications. The application software may comprise a compiled set of machine-readable instructions that configure the DSP 602 to provide the desired functionality, or the application software may be high-level software instructions to be processed by an interpreter or compiler to indirectly configure the DSP 602.

The DSP 602 may communicate with a wireless network via the analog baseband processing unit 610. In some embodiments, the communication may provide Internet connectivity, enabling a user to gain access to content on the Internet and to send and receive e-mail or text messages. The input/output interface 618 interconnects the DSP 602 and various memories and interfaces. The memory 604 and the removable memory card 620 may provide software and data to configure the operation of the DSP 602. Among the interfaces may be the USB port 622 and the infrared port 624. The USB port 622 may enable the UE 600 to function as a peripheral device to exchange information with a personal computer or other computer system. The infrared port 624 and other optional ports such as a Bluetooth® interface or an IEEE 802.11 compliant wireless interface may enable the UE 600 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, a long-term evolution (LTE), a code division multiple access (CDMA), a global system for mobile communications (GSM) wireless communication protocol. In an embodiment, one of the radio transceivers 608 may comprise a near field communication (NFC) transceiver. The NFC transceiver may be used to complete payment transactions with point-of-sale terminals or other communications exchanges. In an embodiment, each of the different radio transceivers 608 may be coupled to its own separate antenna. In an embodiment, the UE 600 may comprise a radio frequency identify (RFID) reader and/or writer device.

The switches 628 may couple to the DSP 602 via the input/output interface 618 to provide one mechanism for the user to provide input to the UE 600. Alternatively, one or more of the switches 628 may be coupled to a motherboard of the UE 600 and/or to components of the UE 600 via a different path (e.g., not via the input/output interface 618), for example coupled to a power control circuit (power button) of the UE 600. The touch screen display 630 is another input mechanism, which further displays text and/or graphics to the user. The touch screen LCD controller 632 couples the DSP 602 to the touch screen display 630. The GPS receiver 638 is coupled to the DSP 602 to decode global positioning system signals, thereby enabling the UE 600 to determine its position.

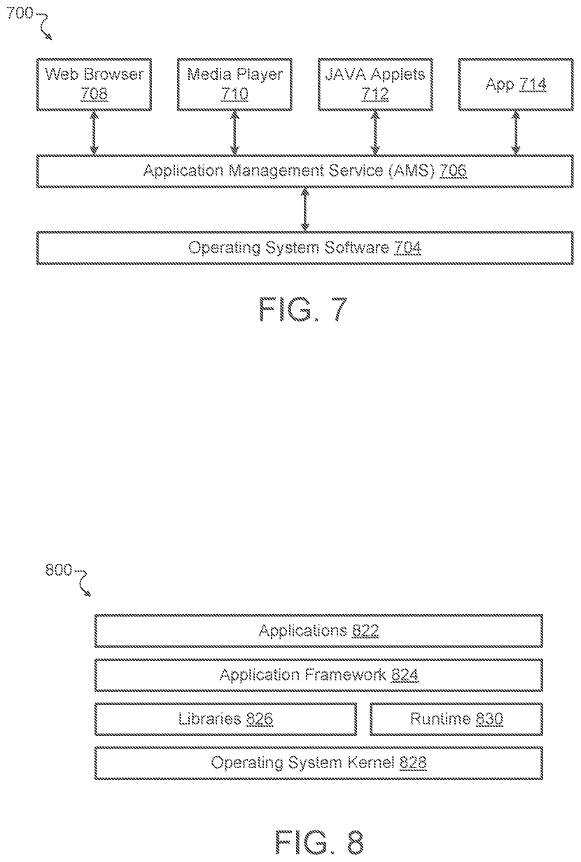

FIG. 7 illustrates a software environment 700 that may be implemented by a DSP, such as the DSP 602 of FIG. 6. The DSP executes operating system software 704 that provides a platform from which the rest of the software operates. The operating system software 704 may provide a variety of drivers for the handset hardware with standardized interfaces that are accessible to application software. The operating system software 704 may be coupled to and interact with application management services (AMS) 706 that transfer control between applications running on a UE, such as UE 500. Also shown in FIG. 7A are a web browser application 708, a media player application 710, and JAVA applets 712. The web browser application 708 may be executed by the UE to browse content and/or the Internet, for example when the UE is coupled to a network via a wireless link. The web browser application 708 may permit a user to enter information into forms and select links to retrieve and view web pages. The media player application 710 may be executed by the UE to play audio or audiovisual media. The JAVA applets 712 may be executed by the UE to provide a variety of functionality including games, utilities, and other functionality.

FIG. 8 illustrates an alternative software environment 800 that may be implemented by a DSP, such as the DSP 602 of FIG. 6. The DSP executes operating system kernel (OS kernel) 828 and an execution runtime 830. The DSP executes applications 822 that may execute in the execution runtime 830 and may rely upon services provided by the application framework 824. Applications 822 and the application framework 824 may rely upon functionality provided via the libraries 826.

While several implementations have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method for using a model that is trained off a computing device to improve voice call quality on the computing device comprising:
receiving, by an application of the computing device, the model that is trained using machine learning and that is configured to determine a given cause of a given event that is affecting given voice call quality on the computing device;
accessing, by the application, device data that indicates characteristics of the computing device;
accessing, by the application, network data that indicates characteristics of a network with which the computing device is communicating;
providing, by the application, the device data, the network data, and data identifying an event that is affecting voice call quality on the computing device as an input to the model;
receiving, by the application and from the model, data indicating a cause of the event;
determining, by the application, an action that improves the voice call quality by remediating the cause of the event; and
performing, by the application, the action that remediates the cause of the event.

2. The method of claim 1, wherein accessing device data that indicates the characteristics of the computing device comprises:
accessing, from a telephony application layer of the computing device, the device data that that indicates the characteristics of the computing device.

3. The method of claim 1, wherein accessing device data that indicates the characteristics of the computing device comprises:
accessing, from a framework module of the computing device, the device data that that indicates the characteristics of the computing device.

4. The method of claim 1, wherein accessing device data that indicates the characteristics of the computing device comprises:
accessing, from a modem of the computing device, the device data that that indicates the characteristics of the computing device.

5. The method of claim 1, wherein accessing device data that indicates the characteristics of the computing device comprises:
accessing, from an interprocess communication module of the computing device, the device data that that indicates the characteristics of the computing device.

6. The method of claim 1, comprising:
generating, by the application, an interface that indicates the event and the action; and
providing, for output by the application, the interface.

7. The method of claim 1, comprising:
receiving, by the application, an updated model that is trained using machine learning and that is configured to determine the given cause of the given event associated with the computing device.

8. The method of claim 1, wherein the model is trained by an additional computing device using machine learning and previous device data, previous network data, data identifying previous events, and previous causes of the previous events.

9. The method of claim 1, wherein determining the action that remediates the cause of the event comprises:
providing, by the application, the device data, the network data, the data identifying the event, and data identifying the cause to an additional model that is configured to output the action.

10. The method of claim 9, wherein the additional model is trained by an additional computing device using machine learning and previous device data, previous network data, data identifying previous events, previous causes of the previous events, and previous actions that remediated the previous events.

11. The method of claim 1, comprising:
receiving, by the application, data indicating whether the action improved the voice call quality of the computing device; and
providing, for output by the application, the data indicating whether the action improved the voice call quality of the computing device.

12. A system, comprising:
one or more processors; and
a memory including a plurality of computer-executable components that are executable by the one or more processors to perform a plurality of acts, the plurality of acts comprising:
determining that an event associated with the system has occurred;
accessing device data that indicates characteristics of the system;
accessing network data that indicates characteristics of a network with which the system is communicating;
based on the device data, the network data, and the event, selecting a model that is configured to receive the device data, the network data, and data identifying the event;
receiving, from the model, data indicating a likely cause of the event;
determining an action that likely remediates the likely cause of the event; and
performing the action that likely remediates the likely cause of the event.

13. The system of claim 12, wherein accessing device data that indicates the characteristics of the system comprises:
accessing, from a telephony application layer, the device data;
accessing, from a framework module, the device data;
accessing, from a modem, the device data; and
accessing, from an interprocess communication module, the device data.

14. The system of claim 12, wherein the plurality of acts comprise:
generating an interface that indicates the event, the likely cause, and the action; and
providing, for output, the interface.

15. The system of claim 12, wherein the plurality of acts comprise:
receiving an updated version of the model that is trained using machine learning and that is configured to determine a given cause of a given event.

16. The system of claim 12, wherein the model is trained by a computing device using machine learning and previous device data, previous network data, data identifying previous events, and previous causes of the previous events.

17. The system of claim 12, wherein determining the action that likely remediates the likely cause of the event comprises:
providing the device data, the network data, the data identifying the event, and data identifying the likely cause to an additional model that is configured to output the action.

18. The system of claim 17, wherein the additional model is trained by a computing device using machine learning and previous device data, previous network data, data identifying previous events, previous causes of the previous events, and previous actions that remediated the previous events.

19. The system of claim 12, wherein the plurality of acts comprise:
receiving data indicating whether the action remediated the likely cause of the event; and
providing, for output, the data indicating whether the action remediated the likely cause of the event.

20. One or more non-transitory computer-readable media storing computer-executable instructions that upon execution cause one or more computers to perform acts comprising:
receiving a model that is trained using machine learning and that is configured to determine a given cause of a given event associated with the one or more computers;
accessing device data that indicates characteristics of the one or more computers;
accessing network data that indicates characteristics of a network with which the one or more computers are communicating;
receiving an updated version of the model;
providing the device data, the network data, and data identifying an event associated with the one or more computers as an input to the updated version of the model;
receiving, from the updated version of the model, data indicating a likely cause of the event;
determining an action that likely remediates the likely cause of the event; and
performing the action that likely remediates the likely cause of the event.
